(19) United States
(12) Patent Application Publication
(10) Pub. No.: US 2018/0143823 A1
(43) Pub. Date: May 24, 2018

(54) METHOD, APPARATUS, AND PROGRAMMABLE APPARATUS FOR INCREMENTAL UPDATE

(71) Applicant: GUANGZHOU UCWEB COMPUTER TECHNOLOGY CO., LTD., Guangzhou (CN)

(72) Inventors: Jinwei HAN, Guangzhou (CN); Zhaomin GUO, Guangzhou (CN)

(21) Appl. No.: 15/819,040

(22) Filed: Nov. 21, 2017

(30) Foreign Application Priority Data
Nov. 21, 2016 (CN) 201611048719.8

(51) Int. Cl. G06F 9/44

(52) U.S. Cl. CPC G06F 8/68; G06F 8/315

(57) ABSTRACT

A method, an apparatus, and a programmable apparatus for incremental update are provided. The method for incremental update includes: according to data structures of a first program object and a second program object, comparing a basic element of the first and second program objects to determine differential information of the basic element between the first and second program objects, where a data structure describes a manner of the basic element for constructing a corresponding program object from the first and second program objects; generating incremental information according to the differential information of the basic element, where the incremental information at least includes update information for the basic element of the first program object; and releasing the incremental information to an update terminal, such that the update terminal updates the first program object to the second program object according to the incremental information.

### CROSS-REFERENCES TO RELATED APPLICATIONS

This application claims priority of Chinese Patent Application No. 201611048719.8, filed on Nov. 21, 2016, the entire contents of which are hereby incorporated by reference.

### FIELD OF THE DISCLOSURE

The present disclosure generally relates to the field of computer technology and, more particularly, relates to a method, an apparatus, and a programmable apparatus for incremental update.

### BACKGROUND

In the field of computer technology, an object often refers to a meaningful area in a memory such as a list, structure, string, etc. With the development of network technology, the object is converted to a binary data stream for transferring over the network or storage on network terminals, which is a common way of operation for objects. For example, ProtoBuffer released by Google is a kind of technical solution for binary serialization of the object, which converts the object into a binary stream for convenient transferring in network and file storage.

However, when the resources are released from server terminals to client terminals based on the object binary serialization technical solution, given the rapid growth of network services, the server terminals often have to release substantially large objects, and the server terminals often adopt a way to release the complete object in the full amount.

Accordingly, even when the object to be released has only a small update, the full amount of the updated object has to be released, which causes great bandwidth loads on the server terminals. The current measured peak bandwidth in a server terminal is approximately 100 Gpbs/min, which also indicates huge cost for network data usage.

In a corresponding binary difference incremental update solution, the serialized binary streams of the old and new objects are compared for differential information, such that incremental information is acquired and released. The receiving terminals are able to update to the new object according to the incremental information in conjunction with the binary stream of the old object.

However, because a series of processing operations are introduced into the binary stream when the binary serialization is applied on the object, the difference between the objects is not consistent with the difference between the binary streams of the objects. Accordingly, the released incremental information is also substantially large, the terminals for releasing increments generally experience huge bandwidth loads, as well as huge cost for network data usage.

The disclosed method, apparatus, and programmable apparatus are directed to solve one or more problems set forth above and other problems in the art.

### BRIEF SUMMARY OF THE DISCLOSURE

One aspect of the present disclosure provides a method for incremental update. The method for incremental update includes: according to data structures of a first program object and a second program object, comparing a basic element of the first and second program objects to determine differential information of the basic element between the first and second program objects, where a data structure describes a manner of the basic element for constructing a corresponding program object from the first and second program objects; generating incremental information according to the differential information of the basic element, where the incremental information at least includes update information for the basic element of the first program object; and releasing the incremental information to an update terminal, such that the update terminal updates the first program object to the second program object according to the incremental information.

Another aspect of the present disclosure provides an apparatus for incremental update. The apparatus for incremental update includes a difference determining unit, for according to data structures of a first program object and a second program object, comparing a basic element of the first and second program objects to determine differential information of the basic element between the first and second program objects, where a data structure describes a manner of the basic element for constructing a corresponding program object from the first and second program objects; an increment generating unit, for generating incremental information according to the differential information of the basic element, where the incremental information at least includes update information for the basic element of the first program object; and an increment releasing unit, for releasing the incremental information to an update terminal, such that the update terminal updates the first program object to the second program object according to the incremental information.

Another aspect of the present disclosure provides a programmable apparatus for incremental update. The programmable apparatus for incremental update includes: at least one processor for according to data structures of a first program object and a second program object, comparing a basic element of the first and second program objects to determine differential information of the basic element between the first and second program objects, generating incremental information according to the differential information of the basic element, and releasing the incremental information to an update terminal, such that the update terminal updates the first program object to the second program object according to the incremental information; and a memory having instructions stored thereon, the instructions executed by the at least one processor.

Other aspects and advantages of the present disclosure can be understood by those skilled in the art through the exemplary embodiments of the present disclosure further described in detail with reference to the accompanying drawings.

### BRIEF DESCRIPTION OF THE DRAWINGS

The accompanying drawings, which are incorporated in and constitute a part of the specification, illustrate embodiments of the present disclosure and, together with the description, serve to explain the principles of the present disclosure.

FIG. 1 illustrates a block diagram of an exemplary hardware configuration of an exemplary computer system consistent with disclosed embodiments;

FIG. 2 illustrates a flowchart of an exemplary incremental update method consistent with disclosed embodiments;

FIG. 3 illustrates another flowchart of an exemplary incremental update method consistent with disclosed embodiments; and

FIG. 4 illustrates a block diagram of an exemplary incremental update apparatus consistent with disclosed embodiments.

### DETAILED DESCRIPTION

Various exemplary embodiments of the present invention will now be described in detail with reference to the accompanying drawings. It should be noted that unless otherwise specifically stated, the relative arrangement of the components and steps, the numerical expressions and numerical values set forth in these embodiments do not limit the scope of the present invention.

The following description including at least one exemplary embodiment is merely for illustrative purposes and is not intended to limit the applications or uses of present invention. Techniques, methods and equipment known by one of ordinary skill in the relevant art may not be discussed in detail, but wherever appropriate, the techniques, methods and equipment should be considered as part of the specification. In all the examples shown and discussed herein, any specific value is construed merely as illustrative, and not as a limitation. Thus, other examples of the exemplary embodiments may have different values.

It should be noted that similar reference numerals and letters denote similar items in the following figures, and thus once an item is defined in one figure, it needs no further discussion in the subsequent figures.

In computer technology, object oriented (OO) concept and applications may be beyond the programming and software development, and may extend to database systems, interactive interface, application architecture, application platform, distributed systems, network management architecture, computer-aided design (CAD) technology, artificial intelligence and other fields.

Object-orientation may be a method to understand and abstract the real world, and may be the outcome of computer technology to a certain stage of development. An object may be various things people want to study, from the simplest integer to the complex aircraft, each of which can be considered as an object. An object may not only be able to represent various things, but also be able to express an abstracted rule, plan or event.

An object may have a state which can be described by data values, and may have an operation for changing the object state. The object and the object operation may be the behavior of the object. The object may implement the combination of data and operations, such that data and operations may be encapsulated in an object entity.

Various things may be an object. By an object-oriented manner, various things in the real world may be abstracted into objects, helping people to implement abstracting and numerical modeling for the real world. This may be useful for carrying out analysis, design and programming on complex systems using the way people understand.

The object may often be converted to a binary data stream for transferring over the network or storage (or memory) on network terminals. The corresponding binary stream of an object may be parsed in the memory and then operated like common objects. The ProtoBuffer scheme, released by Google, may have high parsing performance and high compression ratio technically, thus may often be used to support releasing resources from server terminals to client terminals, client terminal local storage and other suitable services. However, due to the rapid growth of network services, the server terminals may often have to release substantially large objects.

In the binary difference incremental update solution, because a series of processing operations may be introduced into the binary stream when the binary serialization is applied on the object, the difference between the objects may be inconsistent with the difference between the binary streams of the objects, still causing substantially large released incremental information. For example, the Protobuffer file may not be able to keep binary formats consistent, which means that, even when the old and new objects have only a slight difference, the difference between the corresponding binary streams generated may be substantially large.

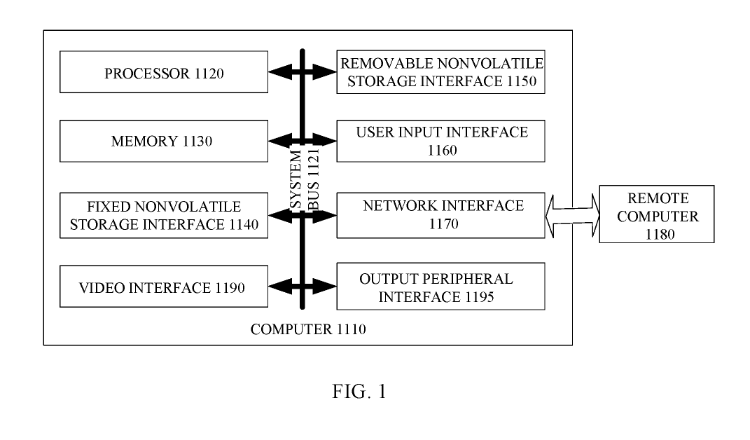

FIG. 1 illustrates a block diagram of an exemplary hardware configuration of an exemplary computer system 1000 consistent with disclosed embodiments. As shown in FIG. 1, a hardware configuration of a computer system 1000 may be provided. The computer system 1000 may include a computer 1110. The computer 1110 may include a processor 1120, a memory 1130, a fixed nonvolatile storage interface 1140, a removable nonvolatile storage interface 1150, a user input interface 1160, a network interface 1170, a video interface 1190 and an output peripheral interface 1195 which are connected via a system bus 1121.

The system memory 1130 may include a read only memory (ROM) and a random access memory (RAM). A basic input output system (BIOS) may reside in the ROM. An operating system, application programs, other program modules and certain program data may reside in the RAM.

A fixed nonvolatile storage such as a hard disk may be connected to the fixed nonvolatile storage interface 1140. The fixed nonvolatile storage may, for example, store an operating system, application programs, other program modules and certain program data.

A removable nonvolatile storage such as a floppy disk drive and a CD-ROM drive may be connected to the removable nonvolatile storage interface 1150. For example, a floppy disk may be inserted into the floppy disk drive, and a compact disc (CD) may be inserted into the CD-ROM drive.

An input apparatus such as a mouse and a keyboard may be connected to the user input interface 1160.

The computer 1110 may be connected to a remote computer 1180 through the network interface 1170. In one embodiment, the network interface 1170 may connect to the remote computer via a local area network. In another embodiment, the network interface 1170 may connect to a modem (modulator-demodulator), and the modem may connect to the remote computer 1180 via a wide area network.

The remote computer 1180 may include a storage such as a hard disk, which may be able to store a remote application program.

The video interface 1190 may be connected to a monitor.

The output peripheral interface 1195 may be connected to a printer and a speaker.

The computer system shown in FIG. 1 is for illustrative purposes and not intended to limit the disclosure, the applications or uses of present invention. In various embodiments of the present disclosure, the memory 1130 of the computer 1110 may be used to store instructions for controlling the processor 1120 to operate and execute the incremental update methods consistent with various embodiments. Although a plurality of devices are shown for the computer 1110 in FIG. 1, the present disclosure may involve some or all of the devices, such as the processor 1120 and the memory 1130 in the computer 1110. Based on the present disclosure, those skilled in the art would be able to design instructions. The instructions may be stored on the memory and may be executed by one or more processors to implement the disclosed methods.

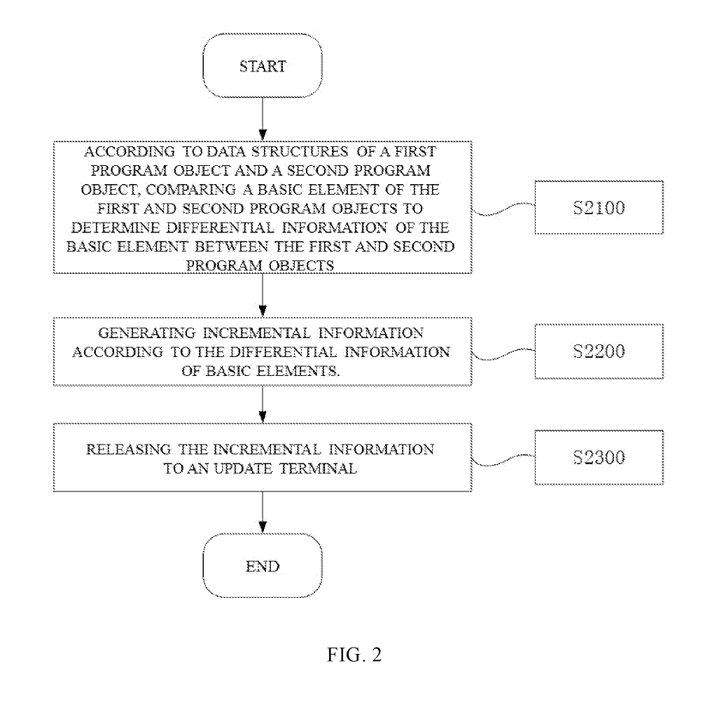

In various embodiments, as shown in FIG. 2, an incremental update method may be provided. The incremental update method may include following steps.

In step S2100, according to data structures of a first application program object (i.e. a first program object) and a second application program object (i.e. a second program object), comparing a basic element of the first and second program objects to determine differential information of the basic element between the first and second program objects, where a data structure may describe a manner of the basic element for constructing a corresponding program object from the first and second program objects, and the differential information of the basic element may be used to denote the basic element having a difference between the second program object and the first program object. As used herein, the terms “application program object” and “program object” may be interchangeably used in the present disclosure.

In various embodiments, the object may be a meaningful area in the memory, and may include a plurality of basic elements. Each object may include basic elements in a different way. In various embodiments, the data structure may be provided to the object, and the data structure of the object may be used for describing the manner in which the object includes the corresponding basic elements. For example, the object may be an object of an object-oriented programming language, such as a Java object; and the data structure of the object may be represented by a class defined in Java. Thus, the program object may refer to the object in a program entity corresponding to an application program (e.g. a mobile phone APP, computer software, etc.) developed or implemented by an object-oriented programming language. For example, an object in the entity of a mobile phone APP. The first program object and the second program object may be objects of entities corresponding to a same application program of different versions or different development time. For example, the first program object may be the object of the entity corresponding to an old application program, and the second program object may be the object of the entity corresponding to the updated application program.

In various embodiments, the basic elements may include data corresponding to basic data types defined in an object-oriented programming language and a character string (a string type). For example, numbers corresponding to the basic data types defined in the Java language and string type data: bool/byte/short/double/float/int/long/string type data.

In one illustrative example, the program object may be:

person: {name=“shangsan”, address=“guangzhou”, age=“25”};
the data structure of the program object may be:

Class Person {

string name;
string address;
int age;

};

and
accordingly the basic elements of the program object may be “shangsan” of the string type, “guangzhou” of the string type and “25” of the int type, which constitute the program object “person” according to the data structure “Person”.

In another illustrative example, the program object may be:

phone: {imei=“123123”, Person owner};
the data structure of the program object may be:

Class Phone {

long imei;
Person owner;

};

and
accordingly the basic elements of the program object may be “123123” of the long type, and the basic elements constituting “owner” (“owner” may have the same data structure as the program object “person” in the preceding example and; in the current example, “owner” may include the same basic elements as the program object “person”), which constitute the program object phone according to the data structure “Phone”.

In another example, the program object may be:

schoolclass: {name=“class1”, List<Person> students}, in which “students” may be a list including 50 program objects having the data structure “Person”;

the data structure of the program object may be:

Class SchoolClass {

string name;
List<Person> students;

};

and
accordingly the basic elements of the program object may be “class1” of the string type and the basic elements of 50 program objects having the data structure “Person” and constituting the list “students”, which constitute the program object “schoolclass” according to the data structure “SchoolClass”.

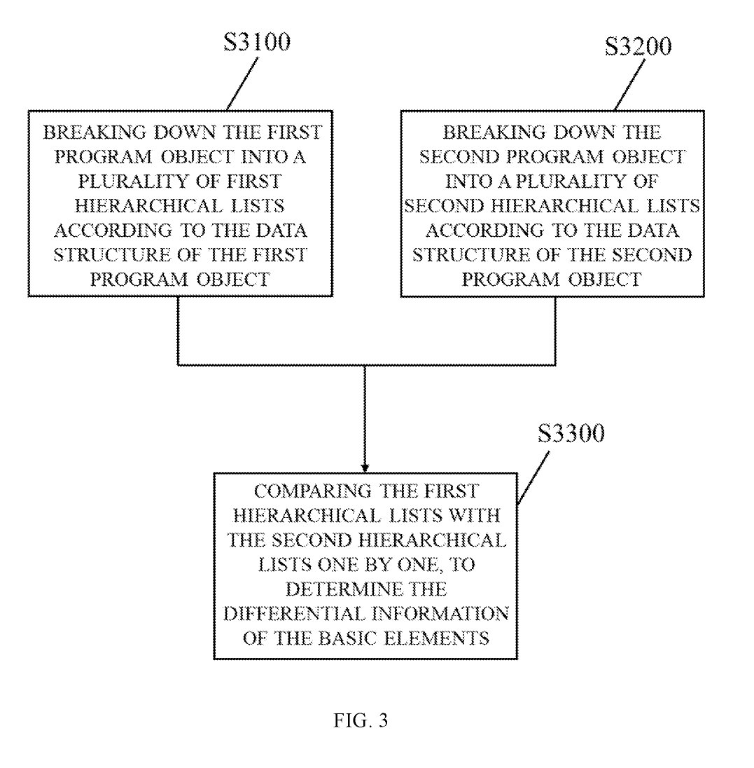

In various embodiments, by comparing the basic elements constituting the first program object with the basic elements constituting the second program object, the basic elements having differences between the second program object and the first program object may be determined, to acquire differential information of the basic elements having differences between the second program object and the first program object, which may, as shown in FIG. 3, further include:

in step S3100, breaking down the first program object into a plurality of first hierarchical lists according to the data structure of the first program object, in which the plurality of first hierarchy lists may include the basic elements of corresponding levels in the data structure of the first program object;

in step S3200, breaking down the second program object into a plurality of second hierarchical lists according to the data structure of the second program object, in which the plurality of second hierarchy lists may include the basic elements of corresponding levels in the data structure of the second program object; and

in step S3300, comparing the first hierarchical lists with the second hierarchical lists one by one, to determine the differential information of the basic elements.

In various embodiments, the order of step S3100 and step S3200 is not limited, and the two steps may be executed concurrently or in any sequences.

For example, the first program object may be the program object “person”: {name=“shangsan”, address=“guangzhou”, age=“25”}. According to the data structure “Person”, the first program object may be broken down into three first hierarchical lists: {name=“shangsan”}, {address=“guangzhou”}, and {age=“25” }.

Assuming the second program object “person1” is {name=“shangsan”, address=“beijing”, age=“25”}, according to the data structure “Person”, the second program object may be broken down into the three second hierarchical lists: {name=“shangsan”}, {address=“beijing”}, and {age=“25”}.

The first hierarchical list {name=“shangsan”} and the second hierarchical list {name=“shangsan”}, the first hierarchical list {address=“guangzhou”} and the second hierarchical list {address=“beijing”}, and the first hierarchical list {age=“25”} and the second hierarchical list {age=“25”} may be compared one by one, for determining the basic element having a difference between the second program object and the first the program object, which is the basic element of the list corresponding to “address”.

Accordingly, the differential information of the basic elements may be used for denoting that the basic element having a difference is the basic element of the list corresponding to “address”. For example, the differential information of the basic element may include a type indicator of the basic element (string type), the content of the basic element, i.e. “beijing”, the structural path of the basic element (the position in the data structure of the program object may be corresponding to the “address”, e.g. /address), and the differential type (i.e. content change).

In another example, the first program object may be the program object “phone”: {imei=“123123”, Person owner}, in which “owner” is an nested program object having a data structure “Person”, in particular, {name=“shangsan”, address=“guangzhou”, age=“25”}. According to the data structure “Phone”, the program object phone may be broken down into the first hierarchical list {imei=“123123”} and the program object “owner”; then according to the data structure “Person” indicated in the data structure “Phone”, the program object “owner” may be broken down into three first hierarchical lists: {name=“shangsan”}, {address=“guangzhou”}, {age=“25”}. Finally, four first hierarchical lists may be acquired: {imei=“123123”}, {name=“shangsan”}, {address=“guangzhou”}, and {age=“25”}.

Assuming the second program object phone1 is {imei=“123123”, Person owner}, in which owner is a nested program object having a data structure “Person”, in particular, {name=“shangsan”, address=“guangzhou”, age=“26”}. According to the data structure “Phone”, the second program object “phone1” may also be broken down into four second hierarchical lists: {imei=“123123” }, {name=“shangsan”}, {address=“guangzhou”}, and {age=“26” }.

The first hierarchical lists and the second hierarchical lists may be compared one by one, for determining that the basic element having a difference between the second program object and the first the program object is the basic element of the list corresponding to “age”. Accordingly, the differential information of the basic element may be used for denoting that the basic element having a difference is the basic element of the list corresponding to “age”. In particular, the differential information of the basic element may include the type indicator of the base element (the int type), the content of the basic element, i.e. “26”, the structural path of the basic element (the position in the data structure of the program object may be corresponding to the “age”, e.g. /owner/age), and the differential type (i.e. content change).

In another example, the first program object may be the program object “schoolclass”. In particular, “schoolclass” may be {name=“class1”, List <Person> students}, in which “students” is a list including 50 program objects having the data structure “Person”. According to the data structure “SchoolClass”, the program object “schoolclass” may be broken down into the first hierarchical list {name=“class1”} and List <Person> students, then according to the structure “List<Person>” indicated in the data structure “SchoolClass”, “students” may be broken down into 50 program objects having the data structure “Person”, and then the 50 program objects having the data structure “Person” may be broken down one by one. Each of the 50 program objects may correspond to three first hierarchical lists {name=“XX”}, {address=“XX”}, and {age=“XX”}, in which the content of “XX” may be different for each program object having the data structure “Person”, which will not be further illustrated. The program object may eventually be broken down into 151 first hierarchical lists.

Assuming the second program object is “schoolclass1” and, in particular, schoolclass1 may be {name=“class1”, List<Person> students}, in which “students” is a list including 51 program objects having the data structure “Person”. Similar to breaking down the first program object “schoolclass”, according to the data structure “SchoolClass”, the second program object “schoolclass1” may be broken down into 154 first hierarchical lists.

The first hierarchical lists and the second hierarchical lists may be compared one by one, for determining that the basic elements having differences between the second program object and the first the program object are the basic elements constituting the 51st program object having the data structure “Person” in the list “students” of the second program object “schoolclass1”.

When assuming: the 51st program object having the data structure “Person” in the list “students” of the second program object “schoolclass1” is: {name=“shangsan”, address=“guangzhou”, age=“25”}, accordingly, the differential information of basic elements may refer to three elements having differences: the type “string”, the content “shangsan”, the structural path “/students &index=51/name” (the 51st of positions corresponding to “name” in the list), the differential type “adding new basic element”; the type “string”, the content “guangzhou”, the structural path “/Students &index=51/address” (the 51st of positions corresponding to “address” in the list), the differential type “adding new basic element”; the type “int”, the content “25”, the structural path “/students &index=51/age” (the 51st of positions corresponding to “age” in the list), the differential type “adding new basic element”. The differential information of basic elements may also refer to the change in the program object in the list “students”. For example, the differential information of basic elements may refer to the program object having differences: the data structure “Person”, the content {name=“shangsan”, address=“guangzhou”, age=“25”}, structural path “/students &index=51”, the differential type “adding new list object”.

Similarly, when the basic elements of the second program object are fewer than the basic elements of the first program object, through the method shown in FIG. 2 or FIG. 3 in various embodiments, the reduced elements in the second program object may be determined, such that the differential information of the basic element may be acquired. For example, the differential type included in the differential information of the basic element may refer to a reduced element or a reduced list object.

In various embodiments, through the method shown in FIG. 2 or FIG. 3, after the basic elements of the second program object are compared with the basic elements of the first program object, the basic elements having differences may be determined, in which only the positions in the data structure of the second program object may be changed for the basic elements. For example, the first program object may be [1, 2, 3, 4, 7], and the second program object may be [1, 7, 3, 4, 2], in which only the positions of the 2nd and 5th basic elements are switched. Instead of considering that both the 2nd basic element and the 5th basic element are updated, the differential information of the basic elements may be determined, which may be the switching between the positions of the 2nd basic element and the 5th basic element. In particular, the differential information of the basic elements may only include the structural path change such as “index=2∥index=5”, and the differential type which may be the switching of the basic elements.

In various embodiments, the examples may have been used to illustrate the determination of the differential information of the basic elements, by comparing the basic elements of the first and second program objects for differences, according to the data structures of the program objects. In one embodiment, the differential information of the basic element having a difference may at least include the type of the basic element having a difference, the content, the differential type and structural path which may be the position of the basic element having a difference in the data structure of the corresponding program object.

After acquiring the differential information in step S2100, proceed to step S2200. In step S2200, incremental information may be generated based on the differential information of the basic elements. The incremental information may at least include the update information with respect to the basic elements of the first program object.

For example, for the second program object “person1”: {name=“shangsan”, address=“beijing”, age=“25”} and the first program object “person”: {name=“shangsan”, address=“guangzhou”, age=“25”}, assume the differential information of the basic element includes the type indicator of the basic element (the “string” type), the content “beijing”, the structural path of the basic element (the position in the data structure of the program object may be corresponding to “address”, e.g. /address), the differential type “content change”. Accordingly, the generated incremental information may include information that: the update mode with respect to the basic element of the first program object is “content update”, the type of the corresponding updated basic element is the “string type”, the content of the corresponding updated basic element is “beijing”, and the structural path of the corresponding updated basic element is “/address”.

In another example, for the second program object “phone1” and the first program object “phone”, assume the differential information of the basic element include the type indicator of the basic element (the “int type”), the content “26”, the structural path of the basic element (the position in the data structure of the program object may be corresponding to the “age”, e.g. /position/age), the differential type “content change”. Accordingly, the generated incremental information may include information that: the update mode with respect to the basic element of the first program object is “content update”, the type of the corresponding updated basic element is the “int type”, the content of the corresponding updated basic element is “26”, and the structural path of the corresponding updated basic element is “/owner/age”.

In another example, for the second program object “schoolclass1” and the first program object “schoolclass”, assume that the differential information of the basic element refers to the change of the object in the list “students”. For example, the object data structure may be “Person” (may actually be structure type number of the data structure “Person” in the corresponding object, such as 10), the content may be {name=“shangsan”, address=“guangzhou”, age=“25”}, and the structural path may be “/students &index=51”, and the differential type may be “adding new list object”. Accordingly, the generated incremental information may include that: the update mode with respect to the basic elements of the first program object is “inserting new list object”, the object type is “Person”, the content is {name=“shangsan”, address=“guangzhou”, age=“25”}, and the structural path is “/students &index=51”.

Similarly, comparisons between the second program object and the first program object may show that a basic element is added or removed, or a list object is removed, and incremental information may be generated accordingly. In the incremental information, the update mode with respect to the basic element of the first program object may be “inserting basic element”, “deleting basic element”, or “deleting list object”.

In addition, when the basic elements that are changed are within the basic elements of the first program object, for example, solely the position switching of the basic elements in the first program object, in the generated incremental information, the update mode with respect to the basic element of the first program object may be instructed as “reuse of basic element”, the element pending update in the first program object may be instructed as a reusable value (e.g. configuring the content to be a specific value such as 1, used for being instructed as the reusable value), and as the corresponding structural path (e.g., instructing structural paths specifically inter-switchable with the basic elements), without including the actual content of the basic elements. Accordingly, the information size of incremental information may be reduced.

In various embodiments, the update information on the basic element of the first program object may at least include an update mode with respect to the basic element of the first program object, the type of the corresponding updated basic element, the content of the corresponding updated basic element, and the structural path of the corresponding updated basic element.

Further, the update information on the basic elements of the first program object may be represented by an object “patch”. The data structure “Patch” of the object “patch” may be:

class Patch{

List<Action> action;
List<NewValue> values;

};

where “Patch” includes a “action” list including a series of “action” and each “action” represents an update on a basic element of the first program object, e.g. updating the content of a basic element, inserting a list object, etc. In particular, the data structure of action may be:

class Action{

int type;
string oldValueLocation;

};

where “type” is the type of the updated basic element of the first program object, and “oldValueLocation” is the structural path of the updated basic element of the first program object.

Further, “Action” may be different types of data structures for different update modes of the first program object, for example:

(1) for content update, “Action” may be:
class UpdateAction extends Action {
Value targetValue; },

where the targetValue is the target content;

(2) for inserting a list object, “Action” may be:

class ListAddAction extends Action {
int index;
Value targetValue;
},

where “index” is the position index of the list object to be inserted and “targetValue” is the content of the list object to be inserted;

(3) for deleting a list object, “Action” may be:

class ListRemoveAction extends Action {
int index;
},

where “index” is the position index of the list object to be deleted.

In addition, “Patch” may also include “Value” corresponding to a series of “Action”, the data structure of “Value” may be:

abstract class Value{
int type;
},

where “type” is the type of the updated basic element of the first program object.

For the basic element in the first program object which may not be directly reused, e.g. changing “guangzhou” to “beijing”, the incremental information may have to include the content “beijing” of the updated basic element in the first program object. Accordingly, the following data structure may be adopted:

class NewValue extends Value{
byte[ ] obj;
},

where “obj” is the content of the basic element.

For the basic element which may be reused in the first program object, the following data structure may be adopted:

class ExistedValue extends Value{
String valueLocation;
};

where “valueLocation” refers to the structural path of the basic element.

The data structure Patch is for illustrative purposes, for describing a possible way for representing the exemplary incremental information in various embodiments.

In various embodiments, the generation of incremental information according to differential information of basic elements may maintain the consistency between the incremental information and the differences of basic elements between the first and second program objects, thereby reducing the information amount of the incremental information, which is different from the incremental update technical solution of binary difference in the existing technology. In the incremental update technical solution of binary difference in the existing technology, the consistency between the incremental information and the difference of the first and second program objects may not be maintained, leading to large amount of information in generated incremental information for only a small difference of the individual basic elements between the first and second program objects.

In various application scenarios, for the same amount of difference between the first and second program objects, the amount of information in the incremental information generated according to the differential information of basic elements may be reduced by more than approximately 90% in various embodiments, compared to the incremental update technical solution of binary difference in the existing technology.

After the generation of the incremental information in step S2200, proceed to step S2300. In step S2300, the incremental information may be released to an update terminal. Accordingly, the update terminal may update the first program object to the second program object according to the incremental information.

In various embodiments, the incremental update method may be applicable to various object updates in the system developed using an object-oriented language. For example, resource updates between the server terminal and the client terminal in the system, resource synchronizations between the server terminals, version updates of the client software program, etc. The objects for updating may vary according to various application scenarios.

The update terminal may be general client terminal apparatuses such as desktop computers, cell phones, tablet computers, notebook computers, etc., may also be server terminal apparatuses such as a blade server, etc., and may also be software application programs, etc. In various embodiments, the update terminal may be connected to the incremental information generating apparatus through a wired or wireless communication, and through a local area network or wide area network.

In various embodiments, the manner in which the incremental information is released is not limited. The incremental information may be released in a custom file format, or may be released in a binary data stream generated by binary serialization of the incremental information based on mechanisms such as Protobuffer. Regardless of the manner for the release, because the generated incremental information in various embodiments may be consistent with the differences of the basic elements between the first and second program objects, under the same condition, the released incremental information may consume much less network data usage than the incremental information generated according to the binary difference technical solution in the existing technology. Accordingly, the bandwidth load on the apparatus for releasing the incremental information may be substantially reduced. In addition, the network data usage consumed for releasing the incremental information may be reduced, and cost for the network data usage may be reduced.

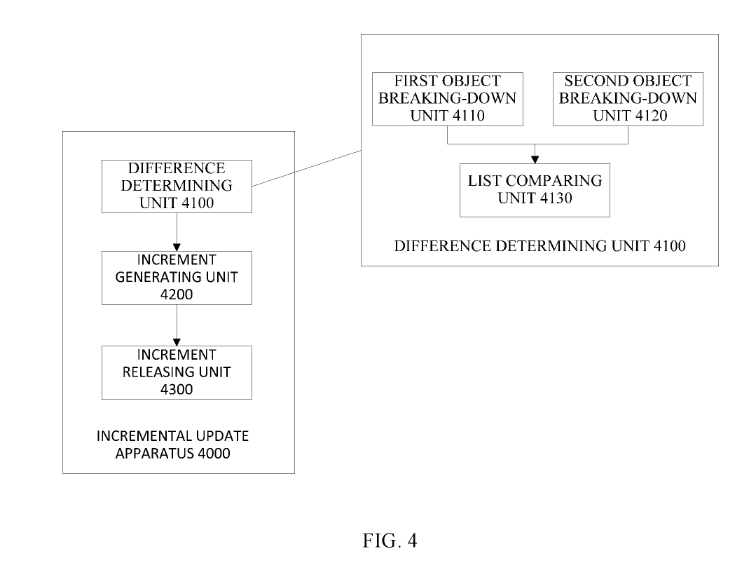

In various embodiments, an incremental update apparatus 4000 may also be provided, as shown in FIG. 4. The incremental update apparatus 4000 may include a difference determining unit 4100, an increment generating unit 4200, and an increment releasing unit 4300, which is for implementing the incremental update method shown in FIG. 2 or FIG. 3 in various embodiments. The incremental updating method which has been described in FIG. 2 or FIG. 3 will not be further described here.

The difference determining unit 4100 may be used for: according to data structures of a first program object and a second program object, comparing a basic element of the first and second program objects to determine differential information of the basic element between the first and second program objects, where a data structure may describe a manner of the basic element for constructing a corresponding program object from the first and second program objects, and the differential information of the basic element may be used to denote the basic element having a difference between the second program object and the first program object.

The increment generating unit 4200 may be used for generating the incremental information according to the differential information of the basic elements. And the incremental information may at least include the update information for the basic elements of the first program object.

The increment releasing unit 4300 may be used for releasing the incremental information to an update terminal, such that the update terminal may update the first program object to the second program object according to the incremental information.

In one embodiment, the difference determining unit 4100 may include:

a first object breaking-down unit 4110, for breaking down the first program object into a plurality of first hierarchical lists according to the data structure of the first program object, in which the plurality of first hierarchy lists may include the basic elements of corresponding levels in the data structure of the first program object;

a second object breaking-down unit 4120, for breaking down the second program object into a plurality of second hierarchical lists according to the data structure of the second program object, in which the plurality of second hierarchy lists may include the basic elements of corresponding levels in the data structure of the second program object; and

a list comparing unit 4130, for comparing the first hierarchical lists with the second hierarchical lists one by one, thereby determining the differential information of the basic elements.

In various embodiments, the implementation of the incremental update apparatus 4000 is not limited. For example, the incremental update apparatus 4000 may be a server terminal apparatus such as a blade server, may also be an external apparatus connected to a server apparatus, and may also be a built-in functional unit in an server terminal apparatus, etc.

In various embodiments, a programmable apparatus may be provided, which may include a memory and at least a processor. The memory may be used to store instructions for controlling the processor to operate and to execute the incremental update method shown in FIG. 2 or FIG. 3. For example, the hardware configuration of the programmable apparatus may be as shown in the computer 1110 in FIG. 1, which will not be further described here.

In various embodiments, the incremental update method has been described in conjunction with the accompanying drawings and examples. The differential information of the basic elements may be determined by comparing the basic elements of the first and second program objects for difference, according to the data structures of the program objects. Accordingly, the incremental information generated based on the differential information of the basic elements may be consistent with the differences between the first and second program objects. Thus, the incremental information based on the differential information of the basic elements may contain much less amount of information than the incremental information based on the incremental update method in the existing technology, substantially reducing the bandwidth load for releasing the incremental information by the apparatus for performing incremental update. In addition, the network data usage consumed for releasing the incremental information may be reduced substantially, and cost for the network data usage may be reduced.

Those skilled in the art would understand that there are various ways to implement the incremental update apparatus 4000. For example, the incremental update apparatus 4000 may be implemented by at least one processor according to a set of instructions. For example, the instructions may be stored in ROM. When the apparatus boots, the instructions may be read from ROM to the programmable devices to implement the incremental update apparatus 4000. For example, the incremental update apparatus 4000 may be integrated into a dedicated device, such as an application specific Integrated circuit (ASIC). The incremental update apparatus 4000 may be divided into separate units, or the units may be combined for the implementation. The incremental update apparatus 4000 may be implemented by one of the above-described various ways for implementation, or combinations of two or more above-described ways for implementation.

In various embodiments, an incremental update method may be provided for updating the corresponding basic elements of the first program object according to the received incremental information, such that the first program object may be updated to the second program object corresponding to the incremental information. The incremental information may at least include the update information for the basic elements of the first program object.

The incremental update method may be implemented by an update terminal. The update terminal may be capable of updating the first program object which is stored locally to the second program object corresponding to the incremental information. The update terminal may be desktop computers, cell phones, tablet computers, notebook computers and other common client terminal devices, and may also be server terminal apparatuses such as a blade server, etc., and may also be software application programs, etc.

In various embodiments, as shown in FIG. 2 or FIG. 3, the received incremental information may be generated and released according to the incremental update method, which will not be further described here.

In various embodiments, the corresponding basic elements of the first program object may be updated according to the received incremental information, such that the first program object may be updated to the second program object corresponding to the incremental information. For example, when the first program object is the program object “person”, and the incremental information includes: the update mode with respect to the basic element of the first program object is “content update”, the type of the corresponding updated basic element is the “string type”, the content is “beijing”, and structural path is “/address”, accordingly, the basic element of the object “person” may be updated from “guangzhou” to “beijing”, such that the object “person” is updated to the object “person1”.

In various embodiments, the implementation for updating the basic elements of the first program object according to the received incremental information may vary. In one embodiment, the incremental information may be a binary data stream sent by Protobuffer mechanism. Accordingly, based on the received binary data stream of the incremental information, the first program object may be updated at the binary data format level according to the incremental information. In another embodiment, when the first program object is a Java object, the first program object may be updated by Java reflection mechanism. In a running status, Java reflection mechanism may be able to call various Java objects, or access the basic elements or data structures of the Java objects, which will not be further described here.

In various embodiments, the received incremental information may at least include the update information for the basic elements of the first program object. The incremental information may be consistent with the differences of basic elements between the local first program object and the second program object which corresponds to the incremental information. The incremental information may contain much less amount of information than incremental information generated by the incremental update method in the existing technology, thereby substantially reducing the cost of network data usage of the update terminal for updating the first program object.

In various embodiments, an incremental update apparatus may be provided for updating the corresponding basic elements of the first program object according to the received incremental information, such that the first program object may be updated to the second program object corresponding to the incremental information. The incremental information may at least include the update information for the basic elements of the first program object. The incremental update apparatus may be used for carrying out the incremental update method in various embodiments, which will not be further described here.

In various embodiments, the incremental update apparatus may exist in a plurality of physical apparatus forms, which may be the update terminals having needs for object update such as desktop computers, cell phones, tablet computers, notebook computers and other common client terminal apparatuses, may also be server terminal apparatuses such as a blade server etc., may also be software application programs etc., may also be an external apparatus connected to an update terminal, and may also be a built-in functional unit in an update terminal.

In various embodiments, a programmable apparatus may be provided, including a memory and a processor. The memory may be used to store instructions for controlling the processor to operate and to execute the incremental update method in various embodiments. In particular, the hardware configuration of the programmable apparatus may be as shown in the computer 1110 of FIG. 1, which will not be further described here.

In various embodiments, according to the received incremental information, the local first program object may be updated to the second program object corresponding to the incremental information. The received incremental information may at least include the update information for the basic elements of the first program object. The incremental information may be consistent with the differences of basic elements between the local first program object and the second program object which corresponds to the incremental information. The incremental information in various embodiments may contain much less amount of information than incremental information generated by the incremental update method in the existing technology, thereby substantially reducing the cost of network data usage of the update terminal for updating the first program object.

Those skilled in the art would understand that various ways may be adopted to implement the incremental update apparatus. For example, the incremental update apparatus may be implemented by at least one processor according to a set of instructions. For example, the instructions may be stored in ROM. When the apparatus boots, the instructions may be read from ROM to the programmable devices to implement the incremental update apparatus. For example, the incremental update apparatus may be integrated into a dedicated device, such as an application specific Integrated circuit (ASIC). The incremental update apparatus may be divided into separate units, or the units may be combined for the implementation. The incremental update apparatus may be implemented by one of the above-described various ways for implementation, or combinations of two or more above-described ways for implementation.

In the present disclosure, an incremental update method, apparatus and programmable apparatus may be provided. The incremental update method may include: according to data structures of a first program object and a second program object, comparing basic elements of the first and second program objects to determine differential information of the basic elements; generating incremental information based on the differential information of the basic elements, such that the incremental information may be consistent with the differences of the basic elements between the first program object and the second program object; and releasing the incremental information to an update terminal, causing the update terminal to update the first program object to the second program object according to the incremental information.

The disclosed incremental update method, apparatus and programmable apparatus in the present disclosure do not exist in the existing technology. Thus, the present disclosure provides a new technical solution.

According to the present disclosure, the incremental information may be consistent with the differences of the basic elements between the first and second program objects. Accordingly, the amount of information of the incremental information may be reduced, and the network data usage for releasing the incremental information may be substantially reduced.

With the development of electronic information technology such as large scale integrated circuit technology and the trend that software functions are implemented by hardware, clearly distinguishing the boundary between hardware and software of the computer system may be substantially difficult. Operations disclosed herein may be implemented by hardware, and may also be implemented by software. The execution of instructions may be completed by hardware, such as one or more processors, and may also be completed by software, or their combinations. Whether to use hardware, software, and/or their combination to realize the machine function may depend on price, speed, reliability, storage capacity, change cycle and other non-technical factors. The operations of the technical solution may be described to clearly illustrate the technical solution in various embodiments. Based on the disclosed embodiments, persons of ordinary skill in the art may derive other embodiments consistent with the present disclosure, all of which are within the scope of the present invention.

The present disclosure may include a system, a method, and/or a computer program product. The computer program product may include a computer readable storage medium (or media), such as a non-transitory computer readable storage medium, having computer readable program instructions thereon for causing a processor to carry out aspects of the present disclosure.

The computer readable storage medium may be a tangible device that is able to retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Those skilled in the art would understand that the implementations by hardware, software or the combination of hardware and software may be equivalent.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. The scope of the present disclosure is defined by the appended claims.

What is claimed is:

1. A method for incremental update, comprising:
according to data structures of a first program object and a second program object, comparing a basic element of the first and second program objects to determine differential information of the basic element between the first and second program objects, wherein a data structure describes a manner of the basic element for constructing a corresponding program object from the first and second program objects;
generating incremental information according to the differential information of the basic element, wherein the incremental information at least comprises update information for the basic element of the first program object; and
releasing the incremental information to an update terminal, such that the update terminal updates the first program object to the second program object according to the incremental information.

2. The method according to claim 1, wherein step for according to the data structures of the first program object and the second program object, comparing the basic element of the first and second program objects to determine the differential information of the basic element between the first and second program objects, comprises:
breaking down the first program object into a plurality of first hierarchical lists according to the data structure of the first program object, wherein the plurality of first hierarchy lists comprise basic elements of one or more corresponding levels in the data structure of the first program object;
breaking down the second program object into a plurality of second hierarchical lists according to the data structure of the second program object, wherein the plurality of second hierarchy lists comprise basic elements of one or more corresponding levels in the data structure of the second program object; and
comparing the first hierarchical lists with the second hierarchical lists one by one, to determine the differential information of the basic element.

3. The method according to claim 1, wherein:
the differential information of the basic element at least includes a type, a content, a differential type, and a structural path of the basic element having a difference.

4. The method according to claim 1, wherein:
the update information for the basic element of the first program object at least includes an update mode for the basic element of the first program object, a type of a corresponding updated basic element, a content of the corresponding updated basic element, and a structural path of the corresponding updated basic element.

5. The method according to claim 1, further comprising:
updating the corresponding basic element of the first program object according to the incremental information that is received, such that the first program object is updated to the second program object corresponding to the incremental information, wherein the incremental information at least includes update information for the basic element of the first program object.

6. The method according to claim 1, wherein:
the basic element at least includes one of data corresponding to a basic data type and a character string of a string type defined in an object-oriented programming language.

7. An apparatus for incremental update, comprising:
a difference determining unit, for according to data structures of a first program object and a second program object, comparing a basic element of the first and second program objects to determine differential information of the basic element between the first and second program objects, wherein a data structure describes a manner of the basic element for constructing a corresponding program object from the first and second program objects;
an increment generating unit, for generating incremental information according to the differential information of the basic element, wherein the incremental information at least comprises update information for the basic element of the first program object; and
an increment releasing unit, for releasing the incremental information to an update terminal, such that the update terminal updates the first program object to the second program object according to the incremental information.

8. The apparatus according to claim 7, wherein the difference determining unit comprises:
a first object breaking-down unit, for breaking down the first program object into a plurality of first hierarchical lists according to the data structure of the first program object, wherein the plurality of first hierarchy lists comprise basic elements of one or more corresponding levels in the data structure of the first program object;
a second object breaking-down unit, for breaking down the second program object into a plurality of second hierarchical lists according to the data structure of the second program object, wherein the plurality of second hierarchy lists comprise basic elements of one or more corresponding levels in the data structure of the second program object; and
a list comparing unit, for comparing the first hierarchical lists with the second hierarchical lists one by one, thereby determining the differential information of the basic element.

9. The apparatus according to claim 7, wherein:
the differential information of the basic element determined by the difference determining unit at least includes a type, a content, a differential type, and a structural path of the basic element having a difference.

10. The apparatus according to claim 7, wherein:
the update information for the basic element of the first program object generated by the increment generating unit at least includes an update mode for the basic element of the first program object, a type of a corresponding updated basic element, a content of the corresponding updated basic element, and a structural path of the corresponding updated basic element.

11. The apparatus according to claim 7, further comprising an update unit for updating the corresponding basic element of the first program object according to the incremental information that is received, such that the first program object is updated to the second program object corresponding to the incremental information, wherein the incremental information at least includes update information for the basic element of the first program object.

12. The apparatus according to claim 7, wherein:
the basic element at least includes one of data corresponding to a basic data type and a character string of a string type defined in an object-oriented programming language.

13. A programmable apparatus for incremental update, comprising:
at least one processor for according to data structures of a first program object and a second program object, comparing a basic element of the first and second program objects to determine differential information of the basic element between the first and second program objects, generating incremental information according to the differential information of the basic element, and releasing the incremental information to an update terminal, such that the update terminal updates the first program object to the second program object according to the incremental information; and
a memory, having instructions stored thereon, the instructions executed by the at least one processor.

14. The programmable apparatus according to claim 13, wherein:
the memory includes a non-transitory computer-readable storage medium having instructions stored thereon.

15. The programmable apparatus according to claim 13, wherein:
a data structure describes a manner of the basic element for constructing a corresponding program object from the first and second program objects.

16. The programmable apparatus according to claim 13, wherein:
the incremental information at least includes update information for the basic element of the first program object.

17. The programmable apparatus according to claim 13, wherein the at least one processor is further configured for:
breaking down the first program object into a plurality of first hierarchical lists according to the data structure of the first program object, wherein the plurality of first hierarchy lists comprise basic elements of one or more corresponding levels in the data structure of the first program object;
breaking down the second program object into a plurality of second hierarchical lists according to the data structure of the second program object, wherein the plurality of second hierarchy lists comprise basic elements of one or more corresponding levels in the data structure of the second program object; and
comparing the first hierarchical lists with the second hierarchical lists one by one, to determine the differential information of the basic element.

18. The programmable apparatus according to claim 13, wherein:
the differential information of the basic element at least includes a type, a content, a differential type, and a structural path of the basic element having a difference.

19. The programmable apparatus according to claim 16, wherein:
the update information for the basic element of the first program object at least includes an update mode for the basic element of the first program object, a type of a corresponding updated basic element, a content of the corresponding updated basic element, and a structural path of the corresponding updated basic element.

20. The programmable apparatus according to claim 13, wherein the at least one processor is further configured for:
updating the corresponding basic element of the first program object according to the incremental information that is received, such that the first program object is updated to the second program object corresponding to the incremental information, wherein the incremental information at least includes update information for the basic element of the first program object.
